(19) United States
(12) Patent Application Publication
(10) Pub. No.: US 2012/0121680 A1
(43) Pub. Date: May 17, 2012

(54) ANIMAL REPELLING DEICER

(75) Inventors: Neil Alexander Rosenburgh, Winsford (GB); Michelle Lee Daum, Kansas City, MO (US); Jason Louis Bagley, Overland Park, KS (US); Dan Pannell, Overland Park, KS (US); Kristopher Shelite, Moundridge, KS (US)

(73) Assignee: NORTH AMERICAN SALT COMPANY, Overland Park, KS (US)

(21) Appl. No.: 13/275,892

(22) Filed: Oct. 18, 2011

Related U.S. Application Data
(60) Provisional application No. 61/394,115, filed on Oct. 18, 2010.

(51) Int. Cl. A01N 25/08; A01K 15/00; A01N 59/08; A01N 37/18; A01N 65/00; A01P 17/00

(52) U.S. Cl. 424/409; 424/545; 424/553; 424/581; 424/677; 514/1.1; 514/627; 119/712

(57) ABSTRACT

Deicing products designed to deter ungulates are provided, along with methods of using those products to treat iced surfaces. The deicing product comprises a mixture of a deicer along with an ungulate repellent. The repellent can repel based on conditioned avoidance, fear, chemical irritation, and/or bad taste. The deicer can be a salt or a deicer solution. The invention is useful for deterring any ungulate that might be attracted to a component of the deicing product (e.g., the salt), but it is particularly useful for deterring deer.

### CROSS-REFERENCE TO RELATED APPLICATIONS

The present application claims the priority benefit of U.S. Provisional Patent Application Ser. No. 61/394,115, filed Oct. 18, 2010, entitled, ANIMAL REPELLING DEICER, incorporated by reference in its entirety herein.

### BACKGROUND OF THE INVENTION

1. Field of the Invention

The present invention relates to deicing products that also deter ungulates from visiting the area being deiced (e.g., a roadway), as well as methods of using those products.

2. Description of the Prior Art

Each winter, regions that receive snow and/or ice must subject roadways and other surfaces to treatment to reduce or prevent snow accumulation and/or ice formation. However, components present in the treatment composition or solution often attract animals to the surface being treated. For example, when salt is present in a deicing product, deer are often attracted to the salt and will visit the treatment area in order to consume the salt. Because there is snow or ice on the ground at the same time the area is being treated, the deer cannot obtain salt from other sources, making the road salt even more appealing to the deer. This creates a particular issue when the surface being treated is a roadway. The deer will wander onto the road while consuming the salt, causing a dangerous traffic hazard.

There is a need for a product that can adequately treat a surface in need of deicing or prevention of icing while also not attracting, and even repelling, ungulates such as deer.

### SUMMARY OF THE INVENTION

The present invention broadly provides a method of reducing ungulate from visiting an area. The method comprises providing a deicing product comprising a deicer and a repellent that is undesirable to the ungulate. The deicing product is introduced to an area where ungulate congregation is undesirable.

The invention is also concerned with a deicing product comprising a deicer and a repellent that is undesirable to an ungulate. The repellent is selected from the group consisting of thiram, predator odors, di(N-alkyl)sulfides, garlic, garlic juice, garlic oils, eggs, sodium of salts of mixed fatty acids, ammonium soaps of higher fatter acids, animal protein, capsaicin, isothiocyanate, denatonium benzoate, thymol, d-limonene, casein, Montok pepper, meat meal, red pepper, capsaicinoid products, castor oil, blood, blood meal, pepper, lithium chloride, scat, gland secretions, and mixtures of the foregoing, the repellent being mixed with and/or coated on the deicer.

In a further embodiment, the invention provides the combination of: a surface from which ungulates are to be deterred; and a deicing product on or adjacent the surface, the deicing product comprising a deicer and a repellent that is undesirable to the ungulate.

### DETAILED DESCRIPTION OF THE PREFERRED EMBODIMENTS

The present invention provides a deicing product that will melt snow and ice and/or prevent the accumulation of snow and ice while also not attracting, and preferably even deterring, ungulates.

In more detail, the deicing product comprises a deicer and a repellent. The deicer can be any conventional deicer, such as a salts and/or deicing solutions. Preferred deicers are selected from the group consisting of potassium succinate, sodium succinate, sodium formate, potassium formate, calcium magnesium acetate, potassium acetate, ethylene glycol, di-ethylene glycol, magnesium chloride, sodium chloride, potassium chloride, calcium chloride, urea, and mixtures of the foregoing. The quantity of deicer present in the deicing product will depend upon the particular deicer that is utilized. For example, when the deicer is sodium chloride, it will typically be included at levels of from about 15% by weight to about 24% by weight, and preferably from about 21% by weight to about 24% by weight, based upon the total weight of the deicing product taken as 100% by weight. When the deicer is magnesium chloride, it will typically be included at levels of from about 20% by weight to about 32% by weight, and preferably from about 27% by weight to about 31% by weight, based upon the total weight of the deicing product taken as 100% by weight. When the deicer is calcium chloride, it will typically be included at levels of from about 25% by weight to about 38% by weight, and preferably from about 28% by weight to about 32% by weight, based upon the total weight of the deicing product taken as 100% by weight. When the deicer is potassium acetate, it will typically be included at levels of from about 30% by weight to about 50% by weight, and preferably from about 45% by weight to about 50% by weight, based upon the total weight of the deicing product taken as 100% by weight. As noted below, the deicing product can be used in a pre-wetting situation as well, and in those instances, the deicer, which will be a solid, will make up the majority (e.g., at least about 60% by weight, and typically from about 70% by weight to about 80% by weight) of the deicing product, with liquid being the remainder. With treated or pre-treated salts, the deicer, which again will be a solid, will take up the bulk (e.g., at least about 95% by weight, and typically from about 95% by weight to about 97% by weight) of the deicing product, with liquid being the remainder.

Preferred repellents include anything that has a deterring effect on the target ungulate. The repellent could deter by providing conditioned avoidance, an undesirable taste (taste modification), chemical irritation, fear, or one of more of the foregoing. Some exemplary repellents include those selected from the group consisting of thiram, predator (e.g., coyote) odors (e.g., urine), di(N-alkyl)sulfides, garlic, garlic juice, garlic oils, eggs (e.g., putrescent egg solids), sodium of salts of mixed fatty acids (e.g., soap), ammonium soaps of higher fatter acids, animal protein, capsaicin, isothiocyanate, denatonium benzoate, thymol, d-limonene, casein, Montok pepper, meat meal, red pepper, capsaicinoid products, castor oil, blood, pepper, lithium chloride, scat, gland secretions, and mixtures of the foregoing. The repellent is preferably present in the deicing product at levels of from about 0.0001% by weight to about 10% by weight, preferably from about 0.01% by weight to about 5% by weight, and more preferably from about 0.01% by weight to about 2.5% by weight, based upon the total weight of the deicing product taken as 100% by weight.

In one embodiment, the deicing product can include additional optional ingredients, such as those selected from the group consisting of corrosion inhibitors, temperature performance enhancers, and additives to promote residual effect. In another embodiment, the deicing product consists essentially of, and preferably consists of, the deicer and the repellent.

The deicing product can be made by simply mixing the repellent with the deicer along with any optional ingredients that are present, preferably at the quantities discussed above. It can also be formed by coating the repellent on the deicer. In a further embodiment, the repellent can be applied directly to the deicing medium (solid or liquid) simultaneous, prior, or immediately prior, to treatment of the surface, discussed in more detail below.

In use, the inventive composition is applied or dispersed onto a surface, such as a roadway, driveway, walkway, sidewalk, patio, porch, parking lot, foot path, other paved surfaces, or any other surface where snow and ice may accumulate to thereby melt or prevent the formation of snow and ice on the treated surface. The rate of application can be adjusted by the user for the particular environment, however, in typical, pre-treated and/or pre-wet, solid-salt application processes for treating roadways, the deicing product is applied to the salt at a rate of from about 4 to about 8 gallons per ton of salt, and that salt is spread at a rate of from about 100 lbs to about 400 lbs per lane mile, and preferably from about 200 lbs to about 400 lbs per lane mile. In a typical, liquid, deicing-product application process, the application rate is typically from about 20 gallons to about 40 gallons per lane mile.

When used to treat roadways, in one embodiment of the invention, a solid deicer is treated with a repellent (may be contained within a liquid deicer) prior to treatment of a highway (e.g., treated salt). In another embodiment, a solid deicer is treated with a repellent additive (may be contained within a liquid deicer) immediately prior to treatment of the roadway (e.g., a pre-wet). In a further embodiment, a liquid deicer is treated with a repellent additive (may be in a solution or may be contained within a liquid deicer) prior to treatment of a highway (e.g., liquid deicer).

Advantageously, the deicing product will decrease, inhibit, deter, and/or prevent ungulate visits and/or congregation in the area that is treated. Ungulates that will be deterred by the present invention include those selected from the group consisting of deer, moose, elk, caribou, mountain goats, and bighorn sheep. The invention has the potential to reduce road traffic collisions by discouraging animals who seek deicing products as part of their diet from congregating on highways.

Furthermore, this deterrence is accomplished without compromising the melt characteristics of the deicing product. That is, when subjected to a melt performance test (defined below), the inventive composition possesses the melt property of generating at least about 1 mL brine per gram of inventive product after about 60 minutes, more preferably from about 1 to about 3 mL brine per gram of inventive product after about 60 minutes, and even more preferably from about 1.5 to about 2.5 mL brine per gram of inventive product after about 60 minutes.

### Melt Performance Test

The melt performance of various compositions can be tested as a function of time and temperature using standardized methodology from the Strategic Highway Research Program (SHRP). Test method SHRP H-205.1 is followed. Flat circular test dishes, 9-in. in diameter and ¾-in. deep are constructed from two pieces of Plexiglas®. One piece is ¼-in.×11-in square and serves as the bottom of the dish, and another piece is ¾-in.×11-in. square with a 9-in. diameter hole cut out of the center, and serves as the sides of the dish when the two pieces are joined together face-to-face. A low-temperature thermometer and a digital timer are then attached to one edge of each dish. The dishes are flushed with ethanol to remove oils and grease.

To prepare the ice, 130 mL of distilled water are placed in each test dish and swirled to distribute the water over the dish surface. The dishes are then placed in a freezer on a level surface and frozen. The dishes are placed in a constant temperature enclosure at 15° F., and equilibrated over night.

Next, about 4.17±0.05 grams of the product to be tested for melt performance are weighed out and placed in the constant temperature enclosure to equilibrate to the testing temperature for 1 hour. The subject deicing product is then spread as uniformly as possible over the ice surface of each respective dish in the constant temperature enclosure. About 15 minutes after applying the deicing compositions, each dish is tilted to allow the generated brine (if any) to flow to the perimeter of the dish. Brine is withdrawn using a syringe for 90 seconds, and the brine volume is recorded. The brine is then returned to the dish by injecting the brine, as much as possible, into the cavities of the ice. The brine collection is repeated at 30 and 60 minutes into the test. The mL of brine per gram of deicer is then calculated for each dish, and the average of three samples is determined. This average is deemed the melt performance property of the product.

### Examples

The following sets forth preferred methods in accordance with the invention. It is to be understood, however, that these examples are provided by way of illustration and nothing therein should be taken as a limitation upon the overall scope of the invention.

### Materials and Methods

### Repellent Products

The products evaluated were three classes of commercially available, non-lethal repellents. Products that repel deer based on taste modification, chemical irritation and fear were evaluated. Repellents based on taste and their respective inclusion rates in free salt are listed in Table 1. Repellents based on chemical irritation and their respective inclusion rates in free salt are listed in Table 2. Repellents based on fear and their respective inclusion rates in free salt are listed in Table 3. One gram of water was used to blend the dry repellents with loose salt in a V-mixer (tumble mixer). Liquid repellents were added directly to salt and blended using the V-mixer. After blending, the adulterated salt was weighed into labeled, channel-lock bags, sealed, and stored for eventual delivery to the test farm.

TABLE 1
Taste Repellents

| | INCLUSION RATE | |
|---|---|---|
| PRODUCT | (% by weight) | FORM |
| Acid casein | 0.34 | Powder |
| Bitrex¹ | 0.013 | Powder |
| Rennet casein | 0.34 | Powder |
| Sodium caseinate | 0.32 | Powder |

¹Denatonium benzoate

TABLE 2
Chemical Irritation Repellents

| | INCLUSION RATE | |
|---|---|---|
| PRODUCT | (% by weight) | FORM |
| Capsaicin | 0.007 | Powder |
| Capsaicin | 0.07 | Powder |
| Lithium chloride | 0.38 | Powder |

TABLE 3
Fear Repellents

| | INCLUSION RATE | |
|---|---|---|
| PRODUCT | (% by weight) | FORM |
| Blood meal¹ | 2.25 | Powder |
| Chicken liver² | 0.6 | Powder |
| Coyote urine | 0.12 | Liquid |
| Putrescent egg³ | 2.1 | Powder |

¹AP301 Powder Porcin, obtained from Plantskydd.
²Spray-dried chicken liver.
³Big Game Repellent Powder, obtained from American Dehydrated Foods.

### Animals and Facilities

Testing was carried out at the farm of a whitetail deer farmer located in Indiana. The testing was carried out by both the farmer and a veterinarian. Approximately twelve deer that ranged in age from 1.5 to 3 years were used in the study. The deer appeared to be healthy at the beginning of the study and maintained satisfactory health during the completion of the study. Signs consistent with clinical disease were not observed, and medical treatments were not administered to any of the deer. The deer were divided into two groups and housed in two separate grass paddocks. Each paddock housed approximately six deer. The size of the paddocks was about 250 ft.×100 ft.

### Feeding

The deer used in the study were fed a diet that was devoid of supplemental salt. Feed was provided in plastic feeders on the ground and inside a wooden, three-sided feeding station that was constructed by the farm owner. Feeding stations were present in both paddocks. Salt was provided free-choice in shallow, black rubber pans, and the pans were housed in a raised, wooden trough that was mounted on the wall of the feeding station. Water was provided to the deer in round plastic containers located within the paddocks. Water and feed were provided to the deer by the farm owner.

Prior to initiation of the study, the salt-free diet and free-choice, unadulterated salt were provided to the deer for a period of one-week to permit acclimation to the feeding regimen. After initiation of the study, access to salt was restricted in an attempt to impose a state of salt deprivation in the deer. Free-choice, unadulterated salt was removed, and the deer were fed the diet deficient in salt for a period of 48 hours to induce salt deprivation. After 48 hours, free-choice salt containing the different repellents was provided. After 48 hours, salt containing the repellents was removed, and another 48-hour period of salt deprivation was imposed followed by provision of adulterated salt for another 48-hour period. The regimen of 48 hours of adulterated salt provision, 48 hours of salt deprivation was used throughout the study and constituted an experimental replication. A total of eight replications were completed for the chemical irritation and fear class of repellents. A total of seven replications were completed for the taste class of repellents.

The pans containing adulterated salt were randomly arranged in the raised, wooden trough on each replication to prevent the deer from becoming habituated to the placement of repellents in a particular position in the trough. A one-week period of access to unadulterated salt was permitted after the final replication of the respective classes of repellents was completed. The experimental period for each class of repellents varied between 28 and 32 days.

### Laboratory

Absolute dry matter of unadulterated salt was determined by drying 1 gram samples in a 212° F. (100° C.) oven for a period of 24 hours. Dry matter of unadulterated salt was determined to be 99.8%. After collection of adulterated and unadulterated salt from the feeding stations, the salt was transferred to aluminum pans and dried in a 131° F. (55° C.) oven for 48 hours to determine physiologic dry matter.

### Data Collected

Salt consumption was determined by calculating the difference between salt provided and salt collected after 48 hours. The data was converted to, and expressed on, a dry matter basis.

### Data Analysis

Consumption data for the two paddocks was merged for analysis. Means for salt consumption were calculated and subjected to analysis of variance (ANOVA) using SAS®. The least significant difference (lsd) test was used as the mean separation procedure. Means for unadulterated salt consumption over the duration of the project was calculated and included in the analysis for each of the repellant classes for purposes of comparison.

### Results

Consumption data for the taste class of repellents is provided in Table 4. Consumption data for the chemical irritation class of repellents is provided in Table 5. Consumption data for the fear class of repellents is provided in Table 6.

TABLE 4
Consumption of Taste Repellents

| | Acid | | Rennet | Sodium | Unadulter- | Standard |
|---|---|---|---|---|---|---|
| ITEM | Casein | Bitrex | Casein | Caseinate | ated Salt | Deviation |
| Salt | 503.14^{a} | 501.64^{a} | 503.85^{a} | 502.64^{a} | 477.76^{b} | 15.93 |
| provided | | | | | | |
| (g) | | | | | | |
| Salt | 495.50^{a} | 494.21^{a} | 494.00^{a} | 496.31^{a} | 469.15^{b} | 15.54 |
| Collected | | | | | | |
| (g) | | | | | | |
| Consumed | 8.21 | 8.29 | 10.43 | 7.62 | 8.62 | 3.41 |
| (g) | | | | | | |

^{a, b}Different superscripts in the same row differ at P < 0.05

TABLE 5
Consumption of Chemical Irritation Repellents

| | | | | Unadul- | |
|---|---|---|---|---|---|
| | Capsaicin | Capsaicin | Lithium | terated | Standard |
| ITEM | (0.007%) | (0.07%) | Chloride | Salt | Deviation |
| Salt provided (g) | 501.87^{a} | 501.69^{a} | 504.69^{a} | 477.76^{b} | 16.93 |
| Salt Collected (g) | 493.81^{a} | 493.00^{a} | 498.00^{a} | 469.15^{b} | 16.60 |
| Consumed (g) | 8.81 | 9.38 | 7.06 | 8.62 | 3.82 |

^{a,b}Different superscripts in the same row differ at P < 0.05

TABLE 6
Consumption of Fear Repellents

| | Putres- | Spray- | | | Unadul- | |
|---|---|---|---|---|---|---|
| | cent | Dried | Blood | Coyote | terated | Standard |
| ITEM | Egg | Liver | Meal | Urine | Salt | Deviation |
| Salt | 512.00^{a} | 503.66^{a} | 509.67^{a} | 501.00^{a} | 477.76^{b} | 27.42 |
| provided | | | | | | |
| (g) | | | | | | |
| Salt | 504.50^{a} | 495.66^{a} | 498.67^{a} | 493.50^{a} | 469.15^{b} | 26.42 |
| Collected | | | | | | |
| (g) | | | | | | |
| Consumed | 7.50 | 8.00 | 11.00 | 7.50 | 8.62 | 4.43 |
| (g) | | | | | | |

^{a, b}Different superscripts in the same row differ at P < 0.05

### DISCUSSION

Several observations indicated that some of the repellents provide the desired effect of rendering road salt undesirable to deer.

### 1. Fear Class Repellents

The fear class repellents were most remarkable in their ability to elicit a notable behavioral response from the deer. Evaluation of the fear class repellents was initiated when the adulterated salt was delivered to the farm. Salt containing all of the fear repellents was placed in the feeding stations at this time. The next day, it was observed that the deer were behaving strangely in their paddocks. For hours, the deer were acting very cautious when approaching the feeding stations and were standing 15-20 feet away from the feeding station with their noses in the air. They gave the appearance of attempting to sample the odor emanating from the feeding station. There was concern that the deer were opting to not enter the feeding station to eat and that their health might be at risk as a result. It was then decided that salt containing only one fear repellent would be provided per experimental replication (48-hour salt provision; 48-hour salt deprivation) in order to avoid putting the deer at risk. From that point until the termination of the study, salt containing only one fear repellent was selected at random and provided to the deer in each paddock. The coyote urine was particularly effective. The deer appeared fearful of this repellant for quite some time. It is believed that they only became less fearful because the heat and humidity likely caused the coyote urine to dissipate due to its volatility. The egg, on the other hand, was most prominent after 48 hours.

Although the consumption data indicates that salt containing the fear compounds was consumed by the deer, the data appears to be erroneous. Based on observations by the veterinarian supervising the study, the pans were not disturbed by the deer during the 48-hour period of allowance and therefore, they did not consume salt. The discrepancy in the data was likely due to possible losses during collection from the pans, although every attempt was made to minimize any spillage or loss of salt during collection. The taste and chemical irritation class of repellents elicited a less dramatic behavior change and evidence of consumption was present based on observations that the pans had been disturbed after salt had been delivered.

### 2. Season

The study would ideally be completed during the winter months to best model the conditions under which the deer are known to show an interest in consuming road salt. There are two issues relevant to the dates of the study period. First, completion of the study during the warmest months of the year exerted a negative effect on feed consumption. The Midwest experienced a very hot summer where a total of 27 days above 90° F. were recorded during the study. As a result of the heat, the daily feed consumption of the deer was depressed but their water consumption was inordinately high during the hotter days of the study. The deer also may have satisfied a portion of their salt requirement through consumption of the grass that grew in the paddocks where they were housed. The growth of the grass in the paddock was lush and had to be mowed several times to control the height. As such, the deer had another readily available source of feed and likely derived some nutritive benefit from the grass. The paddocks did not contain any other bushes, browse, or plant growth that could serve as a nutrient source for the deer. During the winter, the grass is dormant and would not provide a significant nutritive source to the deer during this period. As such, the disruption to feed intake due to the excessive temperatures during the completion of the study and the possibility that the grass supplemented the deer's salt intake may explain why the deer consumed less than their expected daily allowance of salt. The deer were expected to consume one-half ounce (15 grams) of salt daily during the study. However, they failed to achieve that level of daily intake as illustrated in Tables 4-6. Under different environmental conditions where winter temperatures make it necessary to consume adequate calories for maintenance and heat generation, the disruption to feed intake probably would not have occurred. Moreover, the absence of viable grass in the paddocks during winter would have eliminated the potential for deer to supplement their salt intake from grazing.

### 3. Laboratory Errors

An error was committed when determining post-consumption dry matter. Salt was transferred to aluminum pans after collection from the feeding stations and placed in the 131° F. oven to obtain dry matter. The error occurred when the pans of salt were removed from the oven. The pans were removed from the oven and immediately weighed instead of being permitted to equilibrate to room temperature and humidity. As a result, the calculated intake likely is higher than actual intake because of the absence of environmental moisture that would have been present in the salt had it been allowed to equilibrate to room temperature. As such, the consumption values in Tables 4-6 should actually be lower.

We claim:

1. A method of reducing ungulate from visiting an area, said method comprising:
providing a deicing product comprising a deicer and a repellent that is undesirable to said ungulate; and
introducing said deicing product to an area where ungulate congregation is undesirable.

2. The method of claim 1, said deicing product comprising a deicer selected from the group consisting of salts and deicing solutions.

3. The method of claim 2, wherein said deicer is selected from the group consisting of potassium succinate, sodium succinate, sodium formate, potassium formate, calcium magnesium acetate, potassium acetate, ethylene glycol, di-ethylene glycol, magnesium chloride, sodium chloride, potassium chloride, calcium chloride, urea, and mixtures of the foregoing.

4. The method of claim 1, wherein said ungulate is selected from the group consisting of deer, moose, elk, caribou, mountain goats, and bighorn sheep.

5. The method of claim 1, wherein said area is a roadway, driveway, walkway, sidewalk, patio, porch, parking lot, or foot path.

6. The method of claim 1, wherein said repellent repels said ungulate by a mechanism selected from the group consisting of undesirable taste, chemical irritation, fear, or a combination of the foregoing.

7. The method of claim 6, wherein said repellent is selected from the group consisting of thiram, predator odors, di(N-alkyl)sulfides, garlic, garlic juice, garlic oils, eggs, sodium of salts of mixed fatty acids, ammonium soaps of higher fatter acids, animal protein, capsaicin, isothiocyanate, denatonium benzoate, thymol, d-limonene, casein, Montok pepper, meat meal, red pepper, capsaicinoid products, castor oil, blood, blood meal, pepper, lithium chloride, scat, gland secretions, and mixtures of the foregoing.

8. The method of claim 1, wherein said repellent is present in said deicing product at a level of from about 0.0001% by weight to about 10% by weight, based upon the total weight of the deicing product taken as 100% by weight.

9. The method of claim 1, wherein:
said deicer selected from the group consisting of salts and deicing solutions;
said repellent is selected from the group consisting of thiram, predator odors, di(N-alkyl)sulfides, garlic, garlic juice, garlic oils, eggs, sodium of salts of mixed fatty acids, ammonium soaps of higher fatter acids, animal protein, capsaicin, isothiocyanate, denatonium benzoate, thymol, d-limonene, casein, Montok pepper, meat meal, red pepper, capsaicinoid products, castor oil, blood, blood meal, pepper, lithium chloride, scat, gland secretions, and mixtures of the foregoing; and
said ungulate is selected from the group consisting of deer, moose, elk, caribou, mountain goats, and bighorn sheep.

10. The method of claim 1, wherein:
said deicer is selected from the group consisting of potassium succinate, sodium succinate, sodium formate, potassium formate, calcium magnesium acetate, potassium acetate, ethylene glycol, di-ethylene glycol, magnesium chloride, sodium chloride, potassium chloride, calcium chloride, urea, and mixtures of the foregoing;
said repellent is selected from the group consisting of thiram, predator odors, di(N-alkyl)sulfides, garlic, garlic juice, garlic oils, eggs, sodium of salts of mixed fatty acids, ammonium soaps of higher fatter acids, animal protein, capsaicin, isothiocyanate, denatonium benzoate, thymol, d-limonene, casein, Montok pepper, meat meal, red pepper, capsaicinoid products, castor oil, blood, blood meal, pepper, lithium chloride, scat, gland secretions, and mixtures of the foregoing; and
said ungulate is selected from the group consisting of deer, moose, elk, caribou, mountain goats, and bighorn sheep.

11. A deicing product comprising:
a deicer; and
a repellent that is undesirable to an ungulate, said repellent being selected from the group consisting of thiram, predator odors, di(N-alkyl)sulfides, garlic, garlic juice, garlic oils, eggs, sodium of salts of mixed fatty acids, ammonium soaps of higher fatter acids, animal protein, capsaicin, isothiocyanate, denatonium benzoate, thymol, d-limonene, casein, Montok pepper, meat meal, red pepper, capsaicinoid products, castor oil, blood, blood meal, pepper, lithium chloride, scat, gland secretions, and mixtures of the foregoing, said repellent being mixed with and/or coated on said deicer.

12. The product of claim 11, said deicing product comprising a deicer selected from the group consisting of salts and deicing solutions.

13. The product of claim 12, wherein said deicer is selected from the group consisting of potassium succinate, sodium succinate, sodium formate, potassium formate, calcium magnesium acetate, potassium acetate, ethylene glycol, di-ethylene glycol, magnesium chloride, sodium chloride, potassium chloride, calcium chloride, urea, and mixtures of the foregoing.

14. The product of claim 11, wherein said repellent is present in said deicing product at a level of from about 0.0001% by weight to about 10% by weight, based upon the total weight of the deicing product taken as 100% by weight.

15. The product of claim 11, wherein said product consists essentially of said deicer and said repellent.

16. The product of claim 15, wherein said product consists of said deicer and said repellent.

17. The combination of:
a surface from which ungulates are to be deterred; and
a deicing product on or adjacent said surface, said deicing product comprising a deicer and a repellent that is undesirable to said ungulate.

18. The combination of claim 17, wherein said surface is a roadway, driveway, walkway, sidewalk, patio, porch, parking lot, and foot path.

19. The combination of claim 17, said deicing product comprising a deicer selected from the group consisting of salts and deicing solutions.

20. The combination of claim 19, wherein said deicer is selected from the group consisting of potassium succinate, sodium succinate, sodium formate, potassium formate, calcium magnesium acetate, potassium acetate, ethylene glycol, di-ethylene glycol, magnesium chloride, sodium chloride, potassium chloride, calcium chloride, urea, and mixtures of the foregoing.

21. The combination of claim 17, wherein said repellent is present in said deicing product at a level of from about 0.0001% by weight to about 10% by weight, based upon the total weight of the deicing product taken as 100% by weight.

21. The combination of claim 17, wherein said product consists essentially of said deicer and said repellent.

22. The combination of claim 21, wherein said product consists of said deicer and said repellent.
